(19) United States
(12) Patent Application Publication
(10) Pub. No.: US 2017/0068848 A1
(43) Pub. Date: Mar. 9, 2017

(54) DISPLAY CONTROL APPARATUS, DISPLAY CONTROL METHOD, AND COMPUTER PROGRAM PRODUCT

(71) Applicant: Kabushiki Kaisha Toshiba, Tokyo (JP)

(72) Inventors: Tomokazu KAWAHARA, Yokohama Kanagawa (JP); Osamu YAMAGUCHI, Yokohama Kanagawa (JP)

(21) Appl. No.: 15/255,655

(22) Filed: Sep. 2, 2016

(30) Foreign Application Priority Data
Sep. 8, 2015 (JP) 2015-176655

(51) Int. Cl. G06K 9/00; G09G 5/00; G06F 3/00

(52) U.S. Cl. CPC G06K 9/00315; G06K 9/00362; G06F 3/005; G09G 5/003; G09G 2354/00; G09G 2320/10

(57) ABSTRACT

According to an embodiment, a display control apparatus includes one or more hardware processors. The one or more hardware processors acquire observation data obtained by observing a user. The one or more hardware processors identify an attribute of the user based. at least in part on the observation data. The one or more hardware processors detect a presence of a particular reaction of the user to obtain a detection result by processing the observation data using a detection method corresponding to the attribute. The one or more hardware processors control a display based at least in part on a detection result.

### CROSS-REFERENCE TO RELATED APPLICATIONS

This application is based upon and claims the benefit of priority from Japanese Patent Application No. 2015-176655, filed on Sep. 8, 2015; the entire contents of which are incorporated herein by reference.

### FIELD

An embodiment described herein relates generally to a display control apparatus, a display control method, and a computer program product.

### BACKGROUND

There have been developed technologies for detecting a particular reaction, such as a smile, given by a user who views video or the like.

### BRIEF DESCRIPTION OF THE DRAWINGS

FIG. 1 is a diagram of a display control apparatus according to an embodiment;

FIG. 2 is a diagram for explaining an example of a face detection method according to the present embodiment;

FIG. 3 is a diagram of an example of information stored in a first storage unit according to the present embodiment;

FIG. 4 is a diagram of another example of information stored in the first storage unit according to the present embodiment;

FIG. 5 is a flowchart of a processing example;

FIG. 6 is a diagram of an application example of the display control apparatus;

FIG. 7 is a diagram of another application example of the display control apparatus

FIG. 8 is a diagram of still another application example of the display control apparatus;

FIG. 9 is a diagram of still another application example of the display control apparatus; and

FIG. 10 is a diagram of an exemplary hardware configuration of the display control apparatus.

### DETAILED DESCRIPTION

According to an embodiment, a display control apparatus includes one or more hardware processors. The one or more hardware processors acquire observation data obtained by observing a user. The one or more hardware processors identify an attribute of the user based at least in part on the observation data. The one or more hardware processors detect a presence of a particular reaction of the user to obtain a detection result by processing the observation data using a detection method corresponding to the attribute. The one or more hardware processors control a display based at least in part on a detection result.

Exemplary embodiments are described below in greater detail with reference to the accompanying drawings.

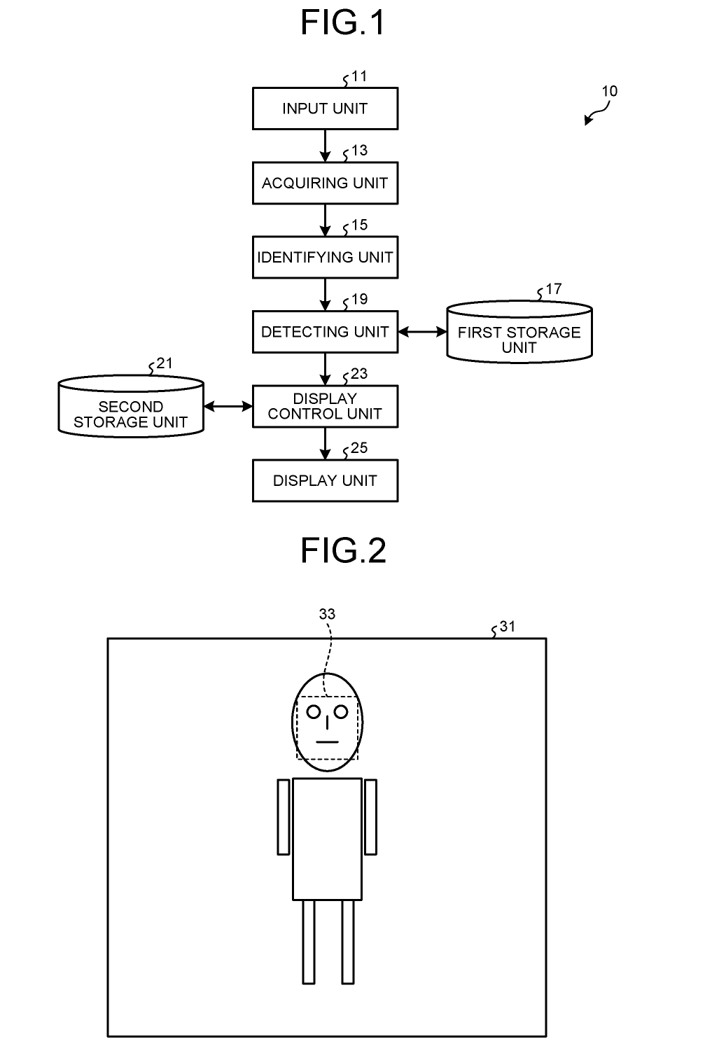

FIG. 1 is a diagram of an exemplary configuration of a display control apparatus 10 according to an embodiment. As illustrated in FIG. 1, the display control apparatus 10 includes an input unit 11, an acquiring unit 13, an identifying unit 15, a first storage unit 17, a detecting unit 19, a second storage unit 21, a display control unit 23, and a display unit 25.

The input unit 11 is an image capturing device, such as a video camera that can shoot video and a camera that can serially take still images. The acquiring unit 13, the identifying unit 15, the detecting unit 19, and the display control unit 23 may be implemented by a processor, such as a central processing unit (CPU), executing a computer program, that is, as software. Alternatively, these units may be provided as hardware, such as an integrated circuit (IC), or a combination of software and hardware. The first storage unit 17 and the second storage unit 21 are a storage device that can magnetically, optically, or electrically store therein data. Examples of the storage device include, but are not limited to, a hard disk drive (HDD), a solid state drive (SSD), a memory card, an optical disc, a read only memory (ROM), and a random access memory (RAM). The display unit 25 is a display device, such as a display.

The input unit 11 receives observation data obtained by observing a user serving as a target of detection of a particular reaction. The observation data includes a captured image obtained by performing image-capturing on the user serving as the target of detection of the particular reaction. The observation data may further include at least one of voice generated by the user serving as the target of detection of the particular reaction and personal information on the user. Examples of the personal information include, but are not limited to, a sex, an age, a nationality, and a name.

In a case where the observation data includes voice, the input unit 11 may be an audio input device, such as a microphone, besides the image capturing device. Alternatively, the input unit 11 may be an image capturing device that can receive audio (including an audio input device).

In a case where the observation data includes personal information and where the personal information is stored in a storage medium, such as a smartphone, a tablet terminal, a mobile phone, and an IC card, belonging to the user serving as the target of detection of the particular reaction, the input unit 11 may be a communication device, such as a near field radio communication device, besides the image capturing device. In this case, the input unit 11 acquires the personal information from the storage medium by near field radio communications.

In a case where the observation data includes personal information and where the personal information is stored in a storage device included in the display control apparatus 10, the input unit 11 may be the storage device besides the image capturing device.

The particular reaction may be any reaction as long as it is given by a user. Examples of the particular reaction include, but are not limited to, smiling, being surprised, being puzzled (being perplexed), frowning, being impressed, gazing, reading characters, and leaving.

The acquiring unit 13 acquires observation data obtained by observing the user serving as the target of detection of the particular reaction. Specifically, the acquiring unit 13 acquires the observation data on the user serving as the target of detection of the particular reaction from the input unit 11.

The identifying unit 15 identifies an attribute of the user serving as the target of detection of the particular reaction based on the observation data acquired by the acquiring unit 13. The attribute is at least one of a sex, an age, a generation (including generation categories, such as child, adult, and the aged), a race, and a name, for example.

To identify an attribute of the user serving as the target of detection of the particular reaction from the captured image included in the observation data, for example, the identifying unit 15 detects a face rectangle 33 from a captured image 31 as illustrated in FIG. 2. Based on the face image in the detected face rectangle 33, the identifying unit 15 identifies the attribute.

To detect the face rectangle, the identifying unit 15 may use a method disclosed in Takeshi Mita, Toshimitsu Kaneko, Bjorn Stenger, Osamu Hori: “Discriminative Feature Go-Occurrence Selection for Object. Detection”, IEEE Transaction Pattern Analysis and Machine Intelligence Volume 30, Number 7, July 2008, pp. 1257-1269, for example.

To identify the attribute based on the face image, the identifying unit 15 may use a method disclosed in Tomoki Watanabe, Satoshi Ito, Kentaro Yoko: “Co-occurrence Histogram of Oriented Gradients for Human Detection”, IPSJ Transaction. on Computer Vision and Applications Volume 2 March 2010, op. 39-47 (which may be hereinafter referred to as a “reference”). The reference describes a technique for determining whether an input pattern is a “user” or a “non-user” using a two-class identifier. To identify three or more types of patterns, the identifying unit 15 simply needs to use two or more two-class identifiers.

For example, in a case where the attribute is the sex, the identifying unit 15 simply needs to determine whether the user is a man or a woman. The identifying unit 15 uses a two-class identifier that determines whether a user is a “man” or a “woman”, thereby determining whether the user having the face image in the face rectangle 33 is a “man” or a “woman”.

For example, in a case where the attribute is the generation and where the identifying unit 15 determines which category the generation of the user falls within out of the three categories of under the age of 20, at the age of 20 or over and under the age of 60, and at the age of 60 or over, the identifying unit 15 uses a two-class identifier that determines whether the generation falls within “under the age of 20” or “at the age of 20 or over” and a two-class identifier that determines whether the generation falls within “under the age of 60” or “at the age of 60 or over”. The identifying unit 15 thus determines which category the generation of the user having the face image in the face rectangle 33 falls within out of “under the age of 20”, “at the age of 20 or over and under the age of 60”, and “at the age of 60 or over”.

In a case where the attribute is the name, the identifying unit 15 uses a method for identifying an individual by a face recognition system disclosed in JP-A No. 2006-221479 (KOKAI), for example, to identify the attribute based on the face image

In a case where the observation data includes personal information, for example, the identifying unit 15 may identify the attribute using the personal information.

The first storage unit 17 stores therein detection methods in a manner associated with respective attributes. This is because movements to show the same particular reaction frequently vary depending on the attributes of the user, and the particular reaction fails to be correctly detected simply by a single detection method. The movements according to the present embodiment include not only movements of a body portion, such as a face and a hand, but also a change in facial expression.

In a case where the particular reaction is smiling, for example, children show a reaction of laughing loudly with their mouth open, for example, whereas adults show a reaction of laughing with a change in facial expression of slightly moving their mouth. Europeans and Americans show a reaction of laughing with their eyes open while clapping their hands and tend to make a larger laughing movement than Asians do.

As described above, movements to show the same reaction vary depending on the attributes of the user. To address this, the present embodiment has methods for detecting the particular reaction by detecting movements specific to respective attributes to show the particular reaction. Examples of the movement to show the particular reaction include, but are not limited to, a change in facial expression, a movement of a face, and a movement of a hand representing the particular reaction.

In a case where algorithms or detectors that detect the presence of the particular reaction vary depending on the attributes, for example, the detection methods associated with the respective attributes correspond to the algorithms or the detectors themselves.

In a case where an algorithm or a detector is shared by the attributes, but dictionary data used by the algorithm or the detector vary depending on the attributes, for example, the detection methods associated with the respective attributes correspond to the dictionary data for the attributes. Examples of the dictionary data include, but are not limited to, training data obtained by performing statistical processing (learning) on a large amount of sample data.

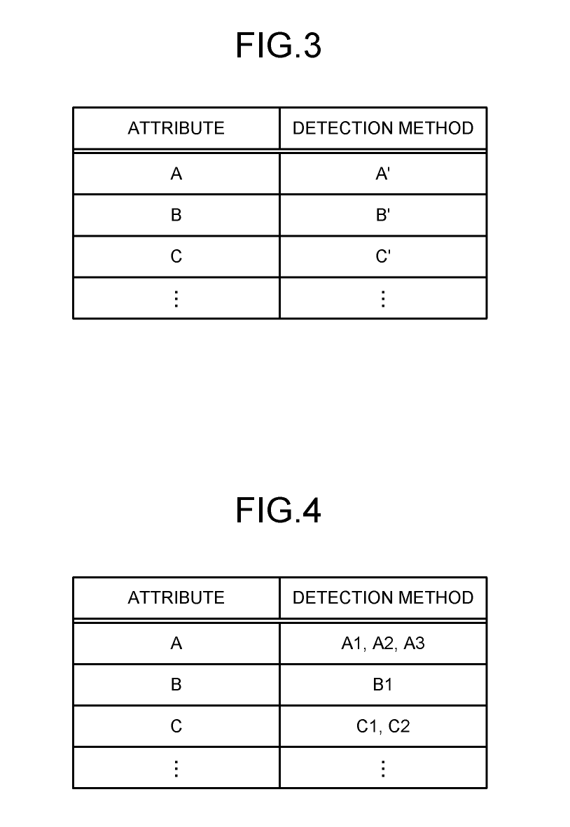

The first storage unit 17 may store therein the detection methods such that one detection method is associated with a corresponding attribute as illustrated in FIG. 3. Alternatively, the first storage unit 17 may store therein the detection methods such that one or more detection methods are associated with a corresponding attribute as illustrated in FIG. 4.

One or more detection methods are associated with a corresponding attribute in a case where a single detection method fails to detect the presence of the particular reaction. In a case where the particular reaction is laughing, for example, laughing includes a loud laugh and a smile. In this case, a single detection method may possibly be able to correctly detect a loud laugh but fail to correctly detect a smile. To address this, both of a method for detecting a loud laugh and a method for detecting a smile are associated with a corresponding attribute.

The method for detecting a loud laugh and the method for detecting a smile, however, are not necessarily associated with all the attributes. The method for detecting a loud laugh and the method for detecting a smile are associated with an attribute in which both of a loud laugh and a smile fail to be correctly detected by a single detection method. By contrast, a single method for detecting a laugh is associated with an attribute in which both of a loud laugh and a smile can be correctly detected by the single detection method.

One or more detection methods are associated with a corresponding attribute also in a case where the presence of the particular reaction can be detected by a plurality of detection methods, that is, a case where a plurality of methods for detecting a laugh are present when the particular reaction is laughing, for example.

The detecting unit 19 detects, from the observation data acquired by the acquiring unit 13, the presence of the particular reaction of the user serving as the detection target using the detection method corresponding to the attribute identified by the identifying unit 15. Specifically, the detecting unit. 19 acquires, from the first storage unit 17, one or more detection methods associated with the attribute identified by the identifying unit. 15. By using the one or more detection methods, the detecting unit 19 detects the presence of the particular reaction of the user serving as the detection target from the observation data (specifically, a captured image) acquired by the acquiring unit 13.

The detection methods stored in the first storage unit 17 according to the present embodiment are dictionary data. The detecting unit 19 uses the dictionary data acquired from the first storage unit 17 by a common detector to detect the presence of the particular reaction of the user serving as the detection target. The detection method of the detector used by the detecting unit 19 may be a detection method performed by a two-class detector described in the reference.

In this case, the result of detection performed by the detecting unit 19 is represented by a value from 0 to 1. As the value is closer to 1, the reliability that the detecting unit 19 detects the particular reaction of the user serving as the detection target increases. By contrast, as the value is closer to 0, the reliability that the detecting unit 19 detects the particular reaction of the user serving as the detection target decreases. If the detection result exceeds a threshold, for example, the detecting unit 19 determines that it detects the particular reaction of the user serving as the detection target. By contrast, if the detection result is smaller than the threshold, the detecting unit 19 determines that it does not detect the particular reaction of the user serving as the detection target..

In a case where the observation data acquired by the acquiring unit 13 includes voice, the detecting unit 19 simply needs to perform at least one of detection of the presence of the particular reaction of the user serving as the detection target using a captured image and detection of the presence of the particular reaction of the user serving as the detection target using voice.

In a case where the particular reaction is laughing and where the attribute is a child (e.g., under the age of 20), for example, to detect the presence of the particular reaction of the user serving as the detection target using a captured image, the detecting unit 19 detects the presence of a laugh by detecting a movement of opening his/her mouth. By contrast, to detect the presence of the particular reaction of the user serving as the detection target using voice, the detecting unit 19 detects the presence of a laugh by detecting a movement of generating a loud voice.

The detecting unit 19, for example, may integrate the detection result of the presence of the particular reaction of the user serving as the detection target using a captured image and the detection result of the presence of the particular reaction of the user serving as the detection target using voice. Then, the detecting unit 19 performs threshold processing on the obtained result to determine the presence of the particular reaction of the user serving as the detection target.

The detecting unit 19, for example, may perform threshold processing on the detection result of the presence of the particular reaction of the user serving as the detection target using a captured image and the detection result of the presence of the particular reaction of the user serving as the detection target using voice if both of the detection results exceed a threshold or if one or the detection results exceeds the threshold, the detecting unit 19 may determine that it detects the particular reaction of the user serving as the detection target.

Also in detection of the presence of the particular reaction of the user serving as the detection target using a plurality of detection methods, the detecting unit 19 determines whether the particular reaction of the user serving as the detection target is detected. In the same manner as that in the case where the observation data includes voice.

The second storage unit 21 stores therein image data of one or more display images. The display images may be video or still images.

The display control unit 23 performs display control based on the result of detection performed by the detecting unit 19.

In a case where the display image is video and where the display control unit 23 acquires image data of video from the second storage unit 21 to display (reproduce) the video on the display unit 25 based on the image data, the user serving as the target of detection of the particular reaction views the reproduced video, and the detecting unit 19 determines whether the user gives the particular reaction after he/she views the video. Tie display control unit 23 may perform display control based on the result of detection performed by the detecting unit 19.

If the detecting unit 19 detects the particular reaction (e.g., laughing), for example, the display control unit 23 may generate a display image indicating that reproduction time and a reproduction frame of the video at which the particular reaction is detected are recorded and display the display image on the display unit 25 in a manner superimposed on the video.

Alternatively, if the detecting unit 19 detects the particular reaction (e.g., laughing), for example, the display control unit 23 may generate a display image for inquiring whether to record reproduction time and a reproduction frame of the video at which the particular reaction is detected and display the display image on the display unit 25 in a manner superimposed on the video.

While the display image generated by the display control unit 23 is assumed to be a still image in the example above, it is not limited thereto.

If the detecting unit 19 does not detect the particular reaction (e.g., laughing), for example, the display control unit 23 may stop displaying (reproducing) the video. By contrast, lithe detecting unit 19 detects the particular reaction, the display control unit 23 may resume or continue displaying (reproducing) the video. With this configuration, the display control unit 23 can cause the user serving as the target of detection of the particular reaction to view the video when he/she is smiling, for example.

If the detecting unit 19 detects the particular reaction, the display control unit 23 may perform display control on the display unit 25.

The display control unit 23, for example, acquires image data of a display image from the second storage unit 21 and displays the display image on the display unit 25 based on the image data. In this case, the user serving as the target of detection of the particular reaction views the display image, and the detecting unit 19 determines whether the user gives the particular reaction after he/she views the display image. If the detecting unit 19 detects the particular reaction, the display control unit 23 changes the display form of the display image displayed on the display unit 25 into a display form based on the attribute identified by the identifying unit 15 and displays the resultant display image.

It is assumed that a first display image is an image for explaining the procedure for use and the functions of the display control apparatus 10, the particular reaction is a reaction of being puzzled, and the attribute is the race. In this case, if the detecting unit. 19 detects a reaction of being puzzled, the display control unit 23 changes the language of the display image into a language corresponding to the race indicated by the attribute and displays the resultant display image.

In this case, if the user serving as the target of detection of the particular reaction is puzzled because he/she does not understand the language of the characters in the display image, the display control unit 23 can automatically change the language of the characters in the display image into a language assumed to be easy for the user to understand.

It is assumed that the first display image is an image for explaining the procedure for use and the functions of the display control apparatus 10, the particular reaction is a reaction of being puzzled, and the attribute is the generation. In this case, lithe detecting unit 19 detects a reaction of being puzzled, and the generation is “child”, the display control unit 23 changes kanji in the display image into hiragana and displays the resultant display image.

In this case, if the user serving as the target of detection of the particular reaction is puzzled because he/she does not understand kanji in the display image, the display control unit 23 can automatically change the kanji in the display image into hiragana assumed to be easy for the user to understand.

It is assumed that the first display image is an image for explaining the procedure for use and the functions of the display control apparatus 10, the particular reaction is a reaction of being puzzled, and the attribute is the generation. In this case, if the detecting unit 19 detects a reaction of being puzzled, and the generation is “the aged”, the display control unit 23 increases the size of the characters in the display image and displays the resultant display image.

In this case, if the user serving as the target of detection of the particular reaction is puzzled because the characters in the display image are hard to see, the display control unit 23 can automatically increase the size of the characters in the display image so as to make them easy for the user to see.

The display control unit 23, for example, acquires image data of the first display image from the second storage unit 21 and displays the first display image on the display unit 25 based on the image data. In this case, the user serving as the target of detection of the particular reaction views the first display image, and the detecting unit 19 determines whether the user gives the particular reaction after he/she views the first display image if the detecting unit 19 detects the particular reaction, the display control unit 23 acquires image data of a second display image from the second storage unit 21 and displays the second display image on the display unit 25 based on the image data.

It is assumed that the first display image is an image for explaining the procedure for use and the functions of the display control apparatus 10, the particular reaction is a reaction of being puzzled, and the second display image is an image for explaining the explanation in the first display image in greater detail or more simply. In this case, if the user serving as the target of detection of the particular reaction is puzzled because he/she does not understand the contents of explanation in the first display image, the display control unit 23 can automatically display the second display image the contents of explanation of which are easy to understand. The second display image may be an image for inquiring whether to display a display image that explains the explanation in the first display image in greater detail or more simply.

The display control unit 23 may not only display the second display image on the display unit 25 but also change the display form of the second display image into a display form based on the attribute identified by the identifying unit 15 as described above.

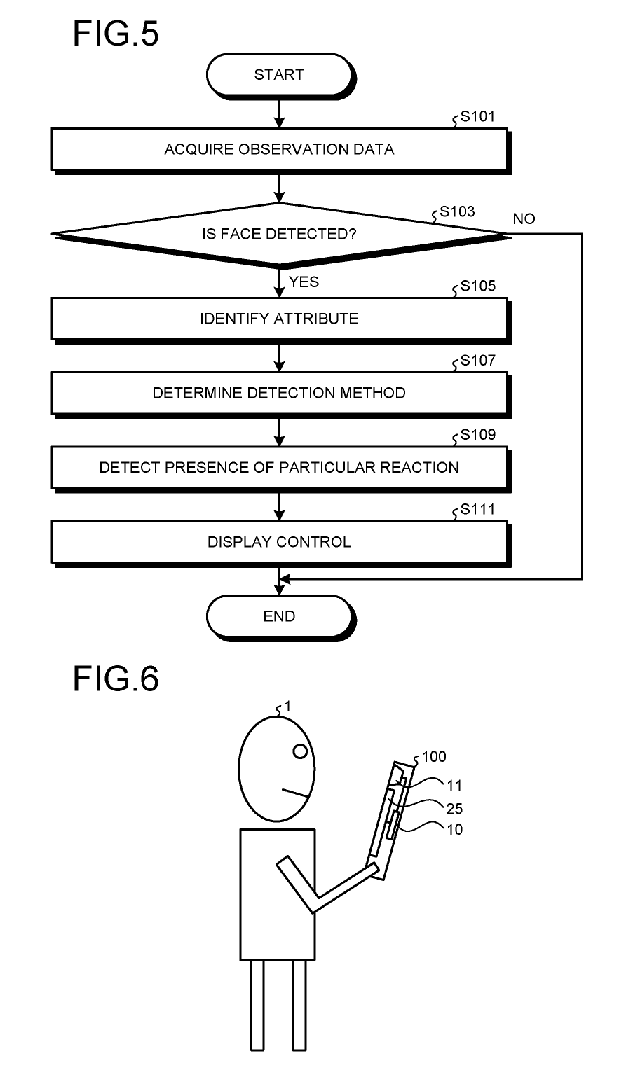

FIG. 5 is a flowchart of an example of a processing flow according to the present embodiment.

The acquiring unit 13 acquires observation data on a user serving as a target of detection of a particular reaction from the input unit 11 (Step S101).

Subsequently, the identifying unit 15 performs face detection on a captured image included in the observation data acquired by the acquiring unit 13 (Step S103). If no face is detected by the face detection (No at Step S103), the processing is finished.

By contrast, if a face is detected by the face detection, that is, if the face of the user serving as the target of detection of the particular reaction is detected (Yes at Step S103), the identifying unit 15 identifies an attribute of the user serving as the target of detection of the particular reaction based on the detected face (face image) (Step S105).

Subsequently, the detecting unit 19 acquires one or more detection methods associated with the attribute identified by the identifying unit 15 from the first storage unit 17 and determines the one or more detection methods to be the methods for detecting the particular reaction (Step S107).

Subsequently, the detecting unit 19 detects the presence of the particular reaction of the user serving as the detection target using the determined one or more detection methods (Step S109).

Subsequently, the display control unit 23 performs display control based on the result of detection performed by the detecting unit 19 (Step S111).

As described above, the present embodiment detects the presence of the particular reaction using the detection method corresponding to the attribute of the user serving as the target of detection of the particular reaction. The present embodiment thus can improve the accuracy in detecting the particular reaction of the user. Furthermore, the present embodiment can correctly detect the presence of the particular reaction independently of the user even in a case where movements to show the particular reaction vary depending on the attributes of the user. As a result, the present embodiment can also improve the accuracy in performing display control using the detection result of the particular reaction of the user.

### APPLICATION EXAMPLES

The following describes specific application examples of the display control apparatus 10 according to the present embodiment.

The display control apparatus 10 according to the present embodiment is applicable to a smart device 100, such as a tablet terminal and a smartphone, illustrated in FIG. 6, for example. In the example illustrated in FIG. 6, the input unit 11 and the display unit 25 are provided to the outside of the display control apparatus 10. In a case where the display control apparatus 10 is applied to the smart device 100 as illustrated in FIG. 6, a user 1 carrying the smart device 100 corresponds to the user serving as the target of detection of the particular reaction.

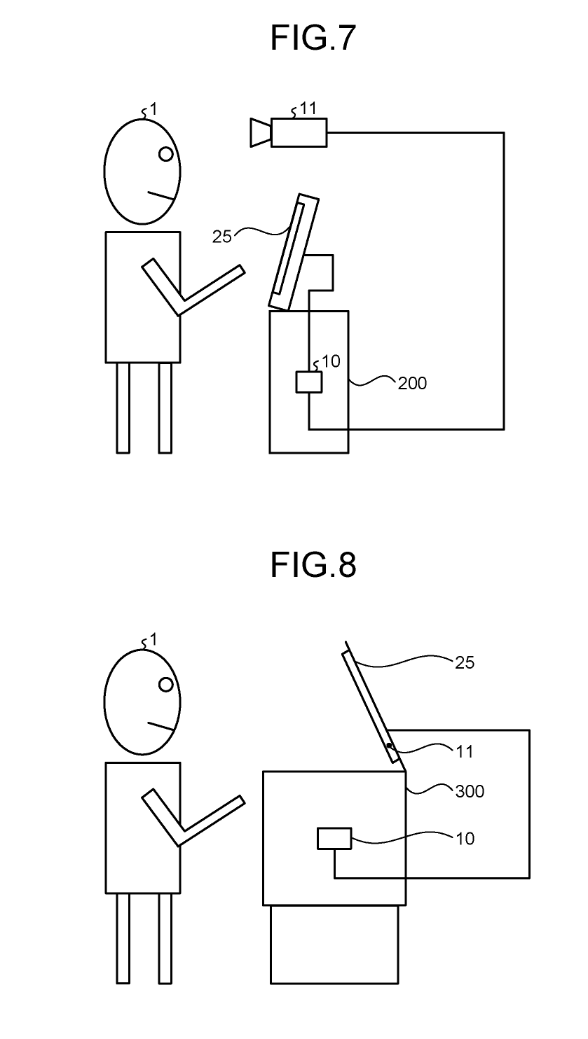

The display control apparatus 10 according to the present embodiment is applicable to a vending machine 200 illustrated in FIG. 7, for example. In the example illustrated in FIG. 7, the input unit 11 and the display unit 25 are provided to the outside of the display control apparatus 10. In a case where the display control apparatus 10 is applied to the vending machine 200 as illustrated in FIG. 7, the user 1 using the vending machine 200 corresponds to the user serving as the target of detection of the particular reaction. The display control apparatus 10 according to the present embodiment is applicable not only to the vending machine 200 but also to a ticket-vending machine that automatically sells tickets, for example.

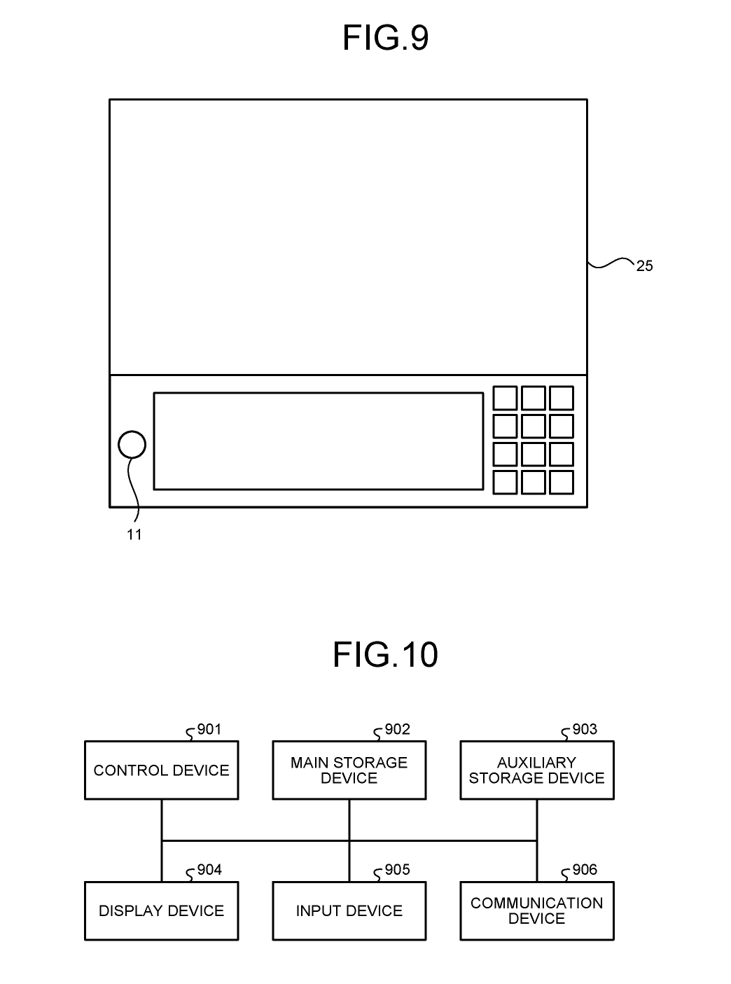

The display control apparatus 10 according to the present embodiment is applicable to an image forming apparatus 300, such as a multifunction peripheral (MEP), a copier, and a printer, illustrated in FIGS. 8 and 9, for example. FIG. 8 is a schematic of an entire configuration of the image forming apparatus 300 according to the present embodiment. FIG, 9 is a schematic of the input unit 11 and the display unit 25 of the image forming apparatus 300 according to the present embodiment. In the example illustrated in FIG. 8, the input unit 11 and the display unit 25 are provided to the outside of the display control apparatus 10. In a case where the display control apparatus 10 is applied to the image forming apparatus 300 as illustrated in FIG. 8, the user 1 using the image forming apparatus 300 corresponds to the user serving as the target of detection of the particular reaction.

Hardware Configuration

FIG. 10 is a diagram of an exemplary hardware configuration of the display control apparatus 10 according to the present embodiment. As illustrated in FIG. 10, the display control apparatus 10 according to the present embodiment includes a control device 901 such as a CPU, a main storage device 902 such as a ROM and a RAM, an auxiliary storage device 903 such as an HDD and an SSD, a display device 904 such as a display, an input device 905 such as a video camera and a microphone, and a communication device 906 such as a communication interface. The display control apparatus 10 has a hardware configuration using a typical computer.

The computer program executed by the display control apparatus 10 according to the present embodiment is recorded and provided in a computer-readable storage medium, such as a compact disc read only memory (CD-ROM), a compact disc recordable (CD-R), a memory card, a digital versatile disc (DVD), and a flexible disk (FD), as an installable or executable file.

The computer program executed by the display control apparatus 10 according to the present embodiment may be stored in a computer connected to a network, such as the Internet, and provided by being downloaded via the network. The computer program executed by the display control apparatus 10 according to the present embodiment may be provided or distributed via a network, such as the Internet. The computer program executed by the display control apparatus 10 according to the present embodiment may be embedded and provided in a ROM, for example.

The computer program executed by the display control apparatus 10 according to the present embodiment has a module configuration to provide the units described above on a computer. In actual hardware, the CPU reads and executes the computer program from the ROM, the HDD, or the like on the RAM, thereby providing the units described above on the computer.

The embodiment described above is not intended to limit the present invention, and the components may be embodied in a variety of other forms without departing from the spirit of the invention. A plurality of components disclosed in the embodiment described above may be appropriately combined to form various inventions. Some components, for example, may be removed from all the components according to the embodiment above. Furthermore, components according to different embodiments may be appropriately combined.

The steps in the flowchart according to the embodiment above, for example, may be executed in another execution order, with some steps executed in parallel, or in a different order in each execution unless contrary to the property.

The present embodiment can improve the accuracy in performing display control using a detection result of a particular reaction of a user.

While a certain embodiment has been described, the embodiment has been presented by way of example only, and is not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A display control apparatus comprising:
one or more hardware processors configured to acquire observation data obtained by observing a user;
to identify an attribute of the user based at least in part on the observation data;
detect a presence of a particular reaction of the user to obtain a detection result by processing the observation data using a detection method corresponding to the attribute; and
control a display based at least in part on a detection result.

2. The apparatus according to claim 1, wherein the attribute comprises at least one of a sex, an age, a generation, a race, or a name.

3. The apparatus according to claim 1, wherein the one or more hardware processors acquires, from a storage that stores therein one or more detection methods in a manner associated with a corresponding attribute, one or more detection methods associated with the attribute of the user and detects the particular reaction using the one or more acquired detection methods.

4. The apparatus according to claim 1, wherein the detection method detects at least one of a change in facial expression, a movement of a face, or a movement of a hand that represents the particular reaction.

5. The apparatus according to claim 1, wherein the one or more hardware processors configured to control the display when the particular reaction is detected.

6. The apparatus according to claim 5, wherein the one or more hardware processors configured to display a display image on a display unit and changes, when the particular reaction is detected, a display form of the display image into a display form based on the attribute and displays the resultant display image on the display unit.

7. The apparatus according to claim 5, wherein the one or more hardware processors configured to display a first display image on a display unit and displays, when the particular reaction is detected, a second display image on the display unit.

8. The apparatus according to claim 7, wherein the one or more hardware processors configured to change a display form of the second display image into a display form based on the attribute and displays the resultant second display image on the display unit.

9. The apparatus according to claim 1, wherein the one or more hardware processors configured to display video on a display unit and performs display control based on the detection result.

10. The apparatus according to claim 1, wherein the observation data comprises a captured image obtained by performing image-capturing on the user.

11. The apparatus according to claim 10, wherein the observation data further comprises at least one of audio generated by the user or personal information on the user.

12. A display control method comprising:
acquiring observation data obtained by observing a user;
identifying an attribute of the user based at least in part on the observation data;
detecting a presence of a particular reaction of the user from the observation data to obtain a detection result by using a detection method corresponding to the attribute; and
controlling a display based at least in part on the detection result.

13. A computer program product comprising a non-transitory computer readable medium comprising programmed instructions, wherein the instructions, when executed by a computer, cause the computer to at least:
acquire observation data obtained by observing a user;
identify an attribute of the user based at least in part on the observation data;
detect a presence of a particular reaction of the user from the observation data to obtain a detection result by using a detection method corresponding to the attribute; and
control a display based at least in part on the detection result.
